(19) United States
(12) Patent Application Publication
(10) Pub. No.: US 2026/0162378 A1
(43) Pub. Date: Jun. 11, 2026

(54) INFORMATION PROCESSING APPARATUS THAT EXECUTES PROCESSING OF SYNTHESIZING VIDEO OF VIRTUAL OBJECT WITH VIDEO OF REAL SPACE

(71) Applicant: CANON KABUSHIKI KAISHA, Tokyo (JP)

(72) Inventor: AKIHITO TAKETANI, Tokyo (JP)

(21) Appl. No.: 19/178,112

(22) Filed: Apr. 14, 2025

(30) Foreign Application Priority Data
Apr. 16, 2024 (JP) 2024-065994

(51) Int. Cl. G06T 19/00; G06F 3/01

(52) U.S. Cl. CPC G06T 19/006; G06F 3/013

(57) ABSTRACT

An information processing apparatus includes one or more processors and at least one memory that is in communication with the one or more processors. The at least one memory stores instructions for causing the one or more processors and the at least one memory to execute first acquisition processing of acquiring a real video that is a video of a real space, execute second acquisition processing of acquiring a virtual video that is a video of a virtual object to be synthesized with the real video, execute analysis processing of analyzing the virtual video, and execute correction processing of correcting the real video on a basis of a result of the analysis processing.

### BACKGROUND

### Field of the Disclosure

The present disclosure relates to an information processing apparatus, and more particularly, to a technology for synthesizing a video of a virtual object with a video of a real space.

### Description of the Related Art

There has been proposed a technique for providing mixed reality (MR) and augmented reality (AR) by displaying a video obtained by synthesizing a video of a virtual object (virtual video) with a video of a real space (real video). Then, with respect to such a technique, a technique for correcting a virtual video in order to reduce the sense of discomfort of the mixed reality and the augmented reality (to make the mixed reality and the augmented reality closer to the sense of real) has been proposed.

JP 2000-352960 A discloses a technique for generating an additional virtual video. JP 2021-056963 A discloses a technique for correcting luminance and chromaticity of a virtual video.

However, in the techniques disclosed in JP 2000-352960 A and JP 2021-056963 A, because the virtual video is added or corrected, the processing amount of the computer is large, and there is a possibility that synthesizing of the virtual video with respect to the real video is delayed. This delay causes positional deviation between the real video and the virtual video in the synthesized video obtained by the synthesizing. Furthermore, when the positional deviation is suppressed, the display of the real video is delayed.

### SUMMARY

Embodiments of the present disclosure provide a technology capable of reducing a sense of discomfort of mixed reality or augmented reality (making the mixed reality or augmented reality closer to the sense of real) while suppressing a significant increase in a processing amount of a computer.

The present disclosure in one aspect provides an information processing apparatus including one or more processors and at least one memory that is in communication with the one or more processors. The at least one memory stores instructions for causing the one or more processors and the at least one memory to execute first acquisition processing of acquiring a real video that is a video of a real space, execute second acquisition processing of acquiring a virtual video that is a video of a virtual object to be synthesized with the real video, execute analysis processing of analyzing the virtual video, and execute correction processing of correcting the real video on a basis of a result of the analysis processing.

The present disclosure in another aspect provides a control method of an information processing apparatus, the control method including acquiring a real video that is a video of a real space, acquiring a virtual video that is a video of a virtual object to be synthesized with the real video, analyzing the virtual video, and correcting the real video on a basis of a result of the analysis.

The present disclosure in another aspect provides a non-transitory computer readable medium that stores computer-executable instructions, wherein the computer-executable instructions cause a computer to execute a control method of an information processing apparatus, the control method including acquiring a real video that is a video of a real space, acquiring a virtual video that is a video of a virtual object to be synthesized with the real video, analyzing the virtual video, and correcting the real video on a basis of a result of the analysis.

Further features of various embodiments will become apparent from the following description of exemplary embodiments with reference to the attached drawings.

### BRIEF DESCRIPTION OF THE DRAWINGS

FIG. 1 is a block diagram illustrating a configuration example of a display device according to a first embodiment;

FIG. 2 is a schematic diagram illustrating an example of various videos according to the first embodiment;

FIG. 3 is a schematic diagram illustrating a configuration example of a display device according to the second embodiment;

FIG. 4 is a schematic diagram illustrating an example of various videos according to the second embodiment;

FIG. 5 is a schematic diagram illustrating a configuration example of a display device according to the third embodiment; and

FIG. 6 is a schematic diagram illustrating an example of various videos according to the third embodiment.

### DESCRIPTION OF THE EMBODIMENTS

### First Embodiment

A first embodiment of the present disclosure is now described. Hereinafter, an example in which the present disclosure is applied to a display device will be described. The display device is, for example, a video see-through type head mounted display (HMD).

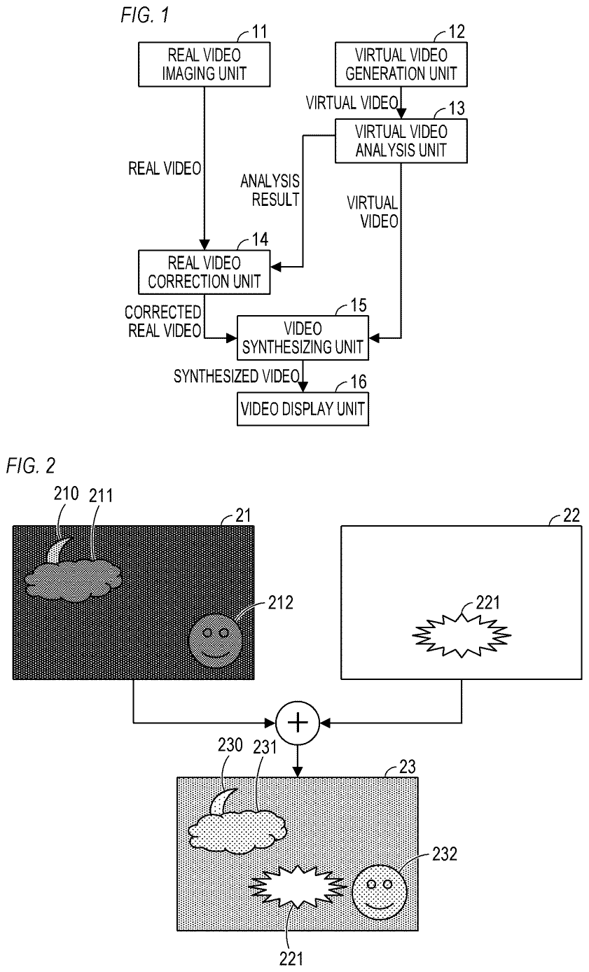

FIG. 1 is a block diagram illustrating a configuration example of a display device according to the first embodiment.

A real video imaging unit 11 acquires video data of a real video (a video of the real space) by capturing the real space. The real video imaging unit 11 includes, for example, a lens group that is an objective optical system and a CMOS image sensor that converts light into an electrical signal. Note that it is sufficient that the real video (video data of the real video) can be acquired. For example, the real video imaging unit 11 may be an external device of an information processing apparatus to which the present disclosure is applied, and the information processing apparatus may have an input interface for acquiring the real video from the outside.

A virtual video generation unit 12 generates a virtual video, which is a video of a virtual object (virtual space) to be synthesized (combined) with a real video. For example, the virtual video generation unit 12 generates video data of a two-dimensional virtual video from data of a three-dimensional model by performing rendering. The virtual video generation unit 12 is, for example, an arithmetic device such as a CPU or a GPU. Note that it is sufficient that the virtual video (video data of the virtual video) can be acquired. For example, the virtual video generation unit 12 may be an external device of an information processing apparatus to which the present disclosure is applied, and the information processing apparatus may have an input interface for acquiring the virtual video from the outside. The real video imaging unit 11 and the virtual video generation unit 12 may be provided in the same device or may be provided in different devices.

When generating a virtual video, the virtual video generation unit 12 estimates the position and orientation of the display device (the real video imaging unit 11). The estimation method is not particularly limited, and for example, the position and orientation may be estimated by analyzing a real video acquired by the real video imaging unit 11, or the position and orientation may be estimated by calculation using a signal output from another imaging unit. The position and orientation may be estimated by calculation using a signal output from a sensor (for example, an acceleration sensor, an angular velocity sensor, or a geomagnetic sensor) different from the image sensor. By using the estimation results of the position and orientation, it is possible to generate a virtual video matching the real video.

A virtual video analysis unit 13 analyzes the virtual video generated by the virtual video generation unit 12. For example, the virtual video analysis unit 13 analyzes metadata of the virtual video (data accompanying the virtual video). The virtual video analysis unit 13 may analyze data of the virtual video before rendering (for example, data of the three-dimensional model). The virtual video analysis unit 13 may analyze data of the virtual video after rendering (for example, video data of the two-dimensional virtual video). Similarly to the virtual video generation unit 12, for example, the virtual video analysis unit 13 is an arithmetic device such as a CPU or a GPU.

A real video correction unit 14 corrects the real video acquired by the real video imaging unit 11 on the basis of the analysis result by the virtual video analysis unit 13. For example, the real video correction unit 14 corrects at least one of luminance, chromaticity, a gamma characteristic, noise, distortion, a position, and resolution of the real video. The real video correction unit 14 is, for example, a semiconductor device such as a DSP, an FPGA, an ISP, or an ASIC. The real video correction unit 14 may be an arithmetic device such as a CPU or a GPU.

A video synthesizing unit 15 synthesizes the virtual video generated by the virtual video generation unit 12 with the real video corrected by the real video correction unit 14. By this processing, a mixed (or augmented) reality video capable of simultaneously viewing the real video and the virtual video is generated. The video synthesizing unit 15 is, for example, a semiconductor device such as a DSP, an FPGA, an ISP, or an ASIC, similarly to the real video correction unit 14. The video synthesizing unit 15 may be an external device of an information processing apparatus to which the present disclosure is applied.

A video display unit 16 displays the video synthesized by the video synthesizing unit 15, that is, the mixed (or augmented) reality video generated by the video synthesizing unit 15. The video display unit 16 includes, for example, a display device, such as a liquid crystal display (LCD) or an organic electroluminescence display (OLED). The video display unit 16 may include an eyepiece optical system. The video display unit 16 may be an external device of an information processing apparatus to which the present disclosure is applied.

FIG. 2 is a schematic diagram illustrating an example of various videos according to the first embodiment.

A video 21 is a real video acquired by the real video imaging unit 11. The real video 21 is a dark, night video and includes a moon 210 and a cloud 211 far away and a face 212 nearby.

A video 22 is a virtual video generated by the virtual video generation unit 12. In the virtual video 22, a flash 221 that shines as a virtual object (CG) is drawn at a position corresponding to the vicinity of the face 212 in the real video 21. The virtual video analysis unit 13 analyzes the virtual video 22.

A video 23 is a synthesized video (a mixed (or augmented) reality video) generated by the video synthesizing unit 15. The real video correction unit 14 corrects the real video 21 on the basis of the analysis result of the virtual video 22, and the video synthesizing unit 15 synthesizes the virtual video 22 with the corrected real video to generate the synthesized video 23.

Because the virtual video 22 includes the flash 221 shining, the real video correction unit 14 increases the luminance of the entire real video 21. Then, the video synthesizing unit 15 synthesizes the virtual video 22 with the real video including the moon 230, the cloud 231, and the face 232 with increased luminance. In this way, it is possible to express a state in which the surrounding luminance is increased by the flash 221, and it is possible to reduce the sense of discomfort of the mixed (or augmented) reality (to make the mixed (or augmented) reality closer to the sense of real).

As described above, according to the first embodiment, the virtual video is analyzed, and the real video is corrected on the basis of the result. Generally, the processing amount of the correction of the real video is smaller than the processing amount of the correction of the virtual video. Therefore, by correcting the real video on the basis of the result of analyzing the virtual video, it is possible to reduce the sense of discomfort of the mixed (or augmented) reality (to make the mixed reality or augmented reality closer to a sense of real) while reducing a significant increase in the processing amount of the computer.

Then, by reducing a significant increase in the processing amount of the computer, it is also possible to reduce a significant delay in synthesizing the virtual video with respect to the real video. As a result, it is also possible to reduce the occurrence of a large positional deviation between the real video and the virtual video in the synthesized video and to reduce a significant delay in the displaying of the real video. Such an effect is remarkably exhibited when the processing of the real video and the processing of the virtual video are performed by different processors (or circuits).

### Second Embodiment

A second embodiment of the present disclosure is now described. In the following description, the same description as in the first embodiment (for example, the description about the same configuration and processing as in the first embodiment) will be omitted, and the difference from the first embodiment will be described. In the second embodiment, not only the virtual video but also the real video is analyzed, and the real video is corrected on the basis of a result of analyzing the virtual video and a result of analyzing the real video.

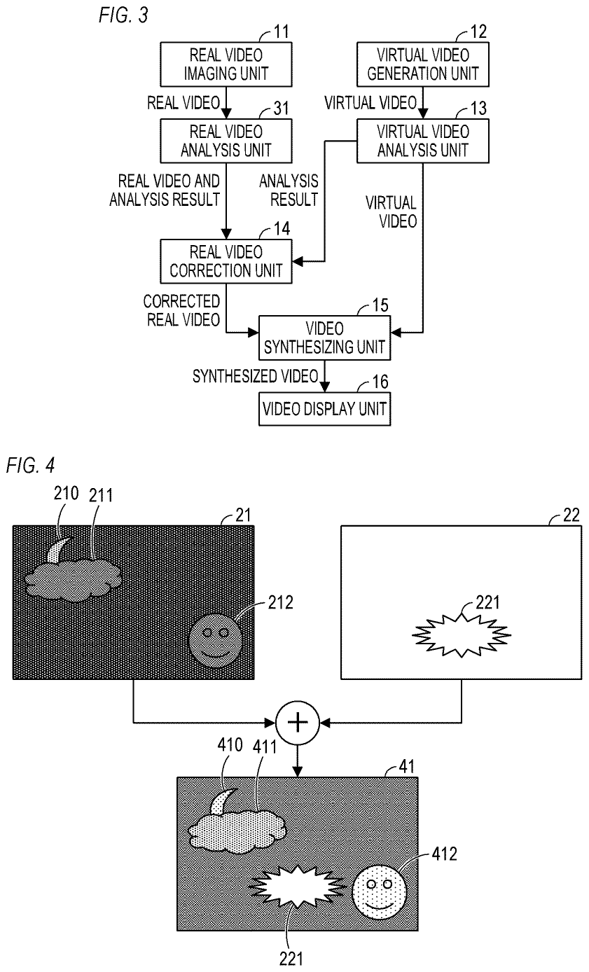

FIG. 3 is a block diagram illustrating a configuration example of a display device according to the second embodiment.

A real video analysis unit 31 analyzes the real video acquired by the real video imaging unit 11. For example, the real video analysis unit 31 not only acquires video information, such as luminance, chromaticity, gamma characteristics, noise, distortion, position, and resolution of the real video, but also acquires depth information of the real video by depth calculation and acquires section information of the real video by segmentation. The real video analysis unit 31 is, for example, a semiconductor device such as a DSP, an FPGA, an ISP, or an ASIC, similarly to the real video correction unit 14.

The real video correction unit 14 corrects the real video acquired by the real video imaging unit 11 on the basis of not only the analysis result by the virtual video analysis unit 13 but also the analysis result by the real video analysis unit 31.

FIG. 4 is a schematic diagram illustrating an example of various videos according to the second embodiment.

A video 41 is a synthesized video generated by the video synthesizing unit 15. The real video correction unit 14 corrects the real video 21 on the basis of the analysis result of the real video 21 and the analysis result of the virtual video 22, and the video synthesizing unit 15 synthesizes the virtual video 22 with the corrected real video to generate the synthesized video 41.

The real video analysis unit 31 acquires section information that sections (indicates) the areas of the moon 210, the cloud 211, and the face 212 by segmentation, and the real video analysis unit 31 acquires depth information indicating the depths of the moon 210, the cloud 211, and the face 212 by depth calculation. Therefore, the real video correction unit 14 slightly increases the luminance of the moon 210 and the cloud 211 far away and greatly increases the face 213 nearby. Then, the video synthesizing unit 15 synthesizes the virtual video 22 with the real video including the moon 410 and the cloud 411 with slightly increased luminance, and the face 412 with greatly increased luminance. In this way, it is possible to express a state in which the luminance of the object far from the flash 221 is less affected by the flash 221 and in which the luminance of the object close to the flash 221 is greatly affected by the flash 221. As a result, the sense of discomfort of the mixed (or augmented) reality can be further reduced (make the mixed (or augmented) reality closer to the sense of real).

As described above, according to the second embodiment, not only the virtual video but also the real video is analyzed, and the real video is corrected on the basis of the result of analyzing the virtual video and the result of analyzing the real video. This makes it possible to further reduce the sense of discomfort of the mixed (or augmented) reality (to make the mixed reality or augmented reality much closer to a sense of real) while reducing a significant increase in the processing amount of the computer.

### Third Embodiment

A third embodiment of the present disclosure is now described. In the following description, the same description as in the second embodiment (for example, the description about the same configuration and processing as in the second embodiment) will be omitted, and the differences from the second embodiment will be described. In the third embodiment, not only the real video but also the virtual video is corrected on the basis of a result of analyzing the virtual video and a result of analyzing the real video.

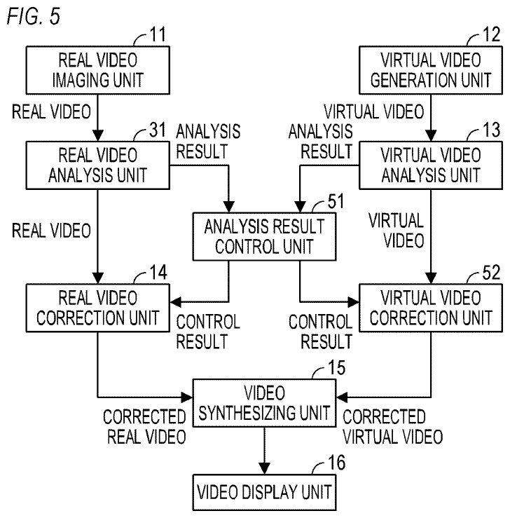

FIG. 5 is a block diagram illustrating a configuration example of a display device according to the third embodiment.

An analysis result control unit 51 performs control to balance the analysis result by the real video analysis unit 31 and the analysis result by the virtual video analysis unit 13 (control to arbitrate the analysis results). For example, the analysis result control unit 51 determines which one of the real video and the virtual video should be corrected according to the analysis result by the real video analysis unit 31 and the analysis result by the virtual video analysis unit 13, and the analysis result control unit 51 performs control to balance the analysis results. Control for balancing the analysis result by the real video analysis unit 31 and the analysis result by the virtual video analysis unit 13 (control for arbitrating the analysis results) may be interpreted as control for balancing the correction of the real video and the correction of the virtual video (control for arbitrating the correction). The analysis result control unit 51 is, for example, a semiconductor device such as a DSP, an FPGA, an ISP, or an ASIC, similarly to the real video correction unit 14.

The real video correction unit 14 corrects the real video acquired by the real video imaging unit 11 on the basis of the result of the control by the analysis result control unit 51.

The virtual video correction unit 52 corrects the virtual video generated by the virtual video generation unit 12 on the basis of the result of the control by the analysis result control unit 51. For example, the virtual video correction unit 52 corrects at least one of luminance, chromaticity, a gamma characteristic, noise, distortion, a position, resolution, and transparency of the virtual video. The virtual video correction unit 52 can also correct the virtual video in consideration of depth information, section information, and the like of the real video. The virtual video correction unit 52 can also perform correction of adding a virtual object as correction of the virtual video. The virtual video correction unit 52 is, for example, a semiconductor device such as a DSP, an FPGA, an ISP, or an ASIC, similarly to the real video correction unit 14. The virtual video correction unit 52 may be an arithmetic device such as a CPU or a GPU.

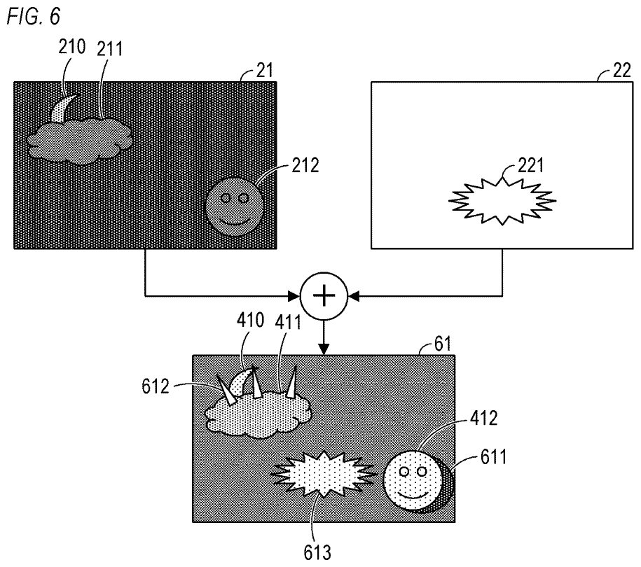

FIG. 6 is a schematic diagram illustrating an example of various videos according to the third embodiment.

A video 61 is a synthesized video generated by the video synthesizing unit 15. The real video correction unit 14 corrects the real video 21 on the basis of the result of the control by the analysis result control unit 51, and the virtual video correction unit 52 corrects the virtual video 22 on the basis of the result of the control by the analysis result control unit 51. Then, the video synthesizing unit 15 generates a synthesized video 61 by synthesizing the corrected virtual video with the corrected real video.

The analysis result control unit 51 determines that the moon 210, the cloud 211, and the face 212 in the real video should be corrected, and the real video correction unit 14 slightly increases the luminance of the moon 210 and the cloud 211 far away and greatly increases the face 213 nearby, similarly to the second embodiment. In addition, the analysis result control unit 51 determines that the virtual video is also to be corrected, and the virtual video correction unit 52 adds a shadow 611 of the face 213 and the light 612 leaking from the cloud 211 to reduce the luminance of the flash 221. Then, the video synthesizing unit 15 synthesizes a virtual video including the shadow 611, the light 612, and the flash 613 with reduced luminance with the real video including the moon 410, the cloud 411, and the face 412 with increased luminance. In this way, it is possible to express a state in which a shadow or light is generated by the flash 221, a state in which the luminance of the flash 221 changes according to the situation (scene) of the real space, and the like. As a result, the sense of discomfort of the mixed (or augmented) reality can be further reduced (make the mixed (or augmented) reality closer to the sense of real).

As described above, according to the third embodiment, not only the real video but also the virtual video is corrected, and the real video is corrected on the basis of the result of analyzing the virtual video and the result of analyzing the real video. This makes it possible to further reduce the sense of discomfort of the mixed (or augmented) reality (to make the mixed reality or augmented reality much closer to a sense of real) while reducing a significant increase in the processing amount of the computer.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiments described above (including variation examples) are merely examples. Any configurations obtained by suitably modifying or changing some configurations of the embodiments within the scope of the object matter of the present disclosure are also included in some embodiments of the present disclosure. Some embodiments of the present disclosure also include other configurations obtained by suitably combining various features of the embodiments.

At least one of the real video correction unit 14 and the virtual video correction unit 52 may change the correction amount according to the angle of view of the display video displayed on the video display unit 16. For example, when the angle of view of the display video is wide, the luminance may be gradually increased or decreased from the center to the end of the display video so that the luminance at the end of the display video approaches the luminance of the surrounding environment. In this way, the sense of discomfort of the mixed (or augmented) reality can be further reduced (make the mixed (or augmented) reality closer to the sense of real). The angle of view of the display video may be equal to the angle of view of the synthesized video, or may be narrower than the angle of view of the synthesized video. That is, the display video may be a synthesized image or a part of the synthesized image.

At least one of the real video correction unit 14 and the virtual video correction unit 52 may change the correction amount according to the line-of-sight position of the user viewing the display video. For example, fine correction may be performed in a portion close to the line-of-sight position, and coarse correction may be performed in a portion far from the line-of-sight position. As a result, it is possible to reduce the processing amount of the computer while reducing the sense of discomfort of the mixed (or augmented) reality (while making the mixed (or augmented) reality closer to the real) and to reduce the processing amount of the computer A method for detecting the line-of-sight position, which is not particularly limited. The line-of-sight sensor that detects the line-of-sight position may or may not be provided in the information processing apparatus to which the present disclosure is applied. It is sufficient that the line-of-sight information regarding the line-of-sight position can be acquired. For example, the line-of-sight sensor may be an external device of the information processing apparatus, and the information processing apparatus may have an input interface for acquiring the line-of-sight information from the outside.

The virtual object is not limited to the flash, and the correction of the real video and the virtual video (the influence of the virtual object on the real video) is not limited to the above-described correction. For example, a virtual object of flame may be used. In this case, as correction of the real video, correction of blurring the flame periphery to express heat haze may be performed. A virtual object of a vehicle may be used. In this case, as the correction of the real video, correction may be performed to distort the real video so as to express the speed feeling of the vehicle. The virtual object is not particularly limited, and the correction of the real video and the virtual video can vary depending on the virtual video (the type of the virtual object and the like), the real video, and the like.

Furthermore, in the above-described embodiments, the case where the present disclosure is applied to the display device has been described as an example, but some embodiments are not limited to this example, and the present disclosure is also applicable to other information processing apparatuses such as a personal computer and a server device.

According to the present disclosure, a technology capable of reducing a sense of discomfort of mixed real or augmented reality (making the mixed reality or augmented reality closer to the sense of real) while suppressing a significant increase in a processing amount of a computer is disclosed.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-065994, which was filed on Apr. 16, 2024 and which is hereby incorporated by reference herein in its entirety.

What is claimed is:

1. An information processing apparatus comprising
one or more processors; and
at least one memory that is in communication with the one or more processors, wherein the at least one memory stores instructions for causing the one or more processors and the at least one memory to:
execute first acquisition processing of acquiring a real video that is a video of a real space;
execute second acquisition processing of acquiring a virtual video that is a video of a virtual object to be synthesized with the real video;
execute analysis processing of analyzing the virtual video; and
execute correction processing of correcting the real video on a basis of a result of the analysis processing.

2. The information processing apparatus according to claim 1, wherein
in the first acquisition processing, the real video is acquired from an image sensor that captures the real space.

3. The information processing apparatus according to claim 1, wherein
the at least one memory further stores instructions for causing the one or more processors and the at least one memory to execute synthesizing processing of synthesizing the virtual video with the real video after the correction processing.

4. The information processing apparatus according to claim 3, further comprising
a display configured to display a video after the synthesizing processing.

5. The information processing apparatus according to claim 1, wherein
in the correction processing, at least one of luminance, chromaticity, a gamma characteristic, noise, distortion, a position, and resolution of the real video is corrected.

6. The information processing apparatus according to claim 1, wherein
the at least one memory further stores instructions for causing the one or more processors and the at least one memory to execute second analysis processing of analyzing the real video, and
in the correction processing, the real video is corrected on a basis of a result of the analysis processing and a result of the second analysis processing.

7. The information processing apparatus according to claim 6, wherein
the result of the second analysis processing includes at least one of depth information and section information of the real video.

8. The information processing apparatus according to claim 6, wherein
in the correction processing, the real video and the virtual video are corrected on a basis of the result of the analysis processing and the result of the second analysis processing.

9. The information processing apparatus according to claim 8, wherein
the correction of the virtual video includes correction of adding a virtual object.

10. The information processing apparatus according to claim 1, wherein
in the analysis processing, metadata of the virtual video is analyzed.

11. The information processing apparatus according to claim 1, wherein
in the analysis processing, data of the virtual video before rendering is analyzed.

12. The information processing apparatus according to claim 1, wherein
in the analysis processing, data of the virtual video after rendering is analyzed.

13. The information processing apparatus according to claim 1, wherein
a display video obtained by synthesizing the virtual video with the real video after the correction processing is displayed on a display, and
in the correction processing, a correction amount is changed according to an angle of view of the display video.

14. The information processing apparatus according to claim 1, wherein
a display video obtained by synthesizing the virtual video with the real video after the correction processing is displayed on a display, and
in the correction processing, a correction amount is changed according to a line-of-sight position of a user viewing the display video.

15. A control method of an information processing apparatus, the control method comprising:
acquiring a real video that is a video of a real space;
acquiring a virtual video that is a video of a virtual object to be synthesized with the real video;
analyzing the virtual video; and
correcting the real video on a basis of a result of the analysis.

16. A non-transitory computer readable medium that stores computer-executable instructions, wherein the computer-executable instructions cause a computer to execute a control method of an information processing apparatus, the control method comprising:
acquiring a real video that is a video of a real space;
acquiring a virtual video that is a video of a virtual object to be synthesized with the real video;
analyzing the virtual video; and
correcting the real video on a basis of a result of the analysis.
